(19) United States
(12) Patent Application Publication
(10) Pub. No.: US 2008/0020181 A1
(43) Pub. Date: Jan. 24, 2008

(54) Decorative adhesive strip for paint application

(76) Inventor: Ann Marie Chafoulias, Orono, MN (US)

Correspondence Address: General Counsel, P.C., 6862 Elm Street, SUITE 800, McLean, VA, 22101, US

(21) Appl. No.: 11/488,300

(22) Filed: Jul. 18, 2006

(51) Int. Cl. B32B 3/00

(52) U.S. Cl. 428/156

(57) ABSTRACT

The present invention is directed to a system for applying a painted pattern to a target surface with an adhesive strip. The adhesive strip, a term meant to encompass adhesive tape, includes a continuous body with recesses. The recesses of the continuous body are decorative in nature and are configured to allow the passage of paint through, or past, the body to a target surface. In order to allow passage of paint, the recesses have a depth that is substantially similar to the height of the body immediately surrounding it. The recesses could take the form of any shape that could be successfully excised from the body of the adhesive strip. The adhesive strip further includes a cleanly-releasable adhesive compound on a ventral surface of the adhesive strip. The adhesive compound is a substance capable of bonding to a surface for a limited period of time without leaving a substantial amount of residue.

### FIELD OF THE INVENTION

The present invention relates to the field of decorative painting and more specifically to the field of clean releasing painters' tape for decorating a surface.

### BACKGROUND

Painting is a chore that few individuals relish. Not that the actual painting process is complicated or physically taxing; the most time-consuming, important painting task is the preparation that occurs beforehand. To ensure that the painted surface has straight edges, the diligent painter outlines the boundaries of the surfaces to be painted before a single dab of paint touches the targeted surface. Tape is currently the prevalent method to demarcate painting boundaries. When shielding a surface from paint, certain types of tape are favored over others.

As the use of tape increased in prominence in demarcating boundaries of painted surfaces, tapes became more specialized. Initially the preferred tool was regular masking tape, which has its origins in demarcating automobile paint lines. Masking tape is typically characterized by a relatively strong adhesive and a backing of easily-torn paper. Masking tape has a strong adhesive that, depending on the target surface, will often pull paint and finish off the masked area upon removal. Among masking tapes, however, there is a specialized type of tape called “painters' tape,” which can be found at any large, comprehensive home maintenance store. Painters' tape differs from conventional tape in that painters' tape uses an adhesive having unique bonding qualities. Painters' tape can be adhered to a surface and then after a reasonable period of time removed without adhesive transfer or surface damage.

Painters' tape has a milder adhesive than normal masking tape. Many adhesive compounds, and variations thereof, can be used with painters' tape; and the choice of adhesive typically depends upon three primary factors: the surface targeted for painting, the expected length of time that the tape will remain on the surface, and the environmental conditions in which the tape will find itself. Low adhesion painters' tape is ideal for smooth, freshly painted surfaces, faux painting, wood floors and glass; medium adhesion painters' tape is ideal for painted walls and trim, woodwork, glass and metal. Painters' tape is further rated by the length of time it can remain adhered to a location prior to transferring a substantial amount of adhesive to surface upon which it is affixed. Although prominent brands of painters' tape currently seems to average a rating of approximately 7 or 14 days, painters' tape can be purchased with a rating of 60 days. Additionally, painters' tape can be purchased with additives that permit the tape to remain in areas with high exposure to sunlight.

Currently painters' tape is primarily used to demarcate boundaries. The unique qualities of painters' tape, however, could be utilized to cleanly create designs on surfaces: particularly proximate to the boundaries that are being covered. Previous attempts to create designs on surfaces, or shield surfaces from paint, with adherent articles have yet to produce a satisfactory article or method permitting design creation with an adherent article. Information relevant to attempts to address these problems can be found in U.S. Pat. Nos. 4,082,875; 4,420,520; 4,430,137; 5,786,028; 7,022,188; D490,855; and D491,229. However, each one of these references suffers from one or more of the following disadvantages: lack of satisfactorily clean adhesion that prevents surface damage while simultaneously preventing unwanted paint migration, absence of supportive backing, purely utilitarian functions, the inability to allow a user to define the required dimensions of paint boundaries and decorations, and structure requiring a user to undertake additional work to prepare a pattern.

Therefore, there is a need for a decorative tape that includes an adhesive compound that cleanly releases from a great range of target surfaces, a backing capable of satisfactorily accepting established recesses, and body dimensions that allow a user to choose a predetermined amount of tape.

### SUMMARY

The present invention is directed to a system for applying a painted pattern to a target surface with an adhesive strip. The adhesive strip, a term meant to encompass acceptable varieties of adhesive tape, includes a continuous body with recesses. The recesses of the body could include inner recesses, i.e. recesses substantially enclosed within the continuous body; outer recesses, i.e. recesses affecting the dimensions of the outer edge of the continuous body; or a combination of outer recesses and inner recesses.

The recess of the continuous body are decorative in nature and are configured to allow the passage of paint through, or past, the body to a target surface. In order to allow passage of paint, the recesses have a depth that is substantially similar to the height of the body immediately surrounding it. The recesses could take the form of any shape that could be successfully excised from the body of the adhesive strip. For example, the recesses could comprise letters, numbers, geometric shapes, scenic designs, repeated patterns, etc.

The adhesive strip further includes a cleanly-releasable adhesive compound on a ventral surface of the adhesive strip. The adhesive compound is a substance capable of bonding to a surface for a limited period of time without leaving a substantial amount of residue. The ideal adhesive compounds for the present invention include those found, or capable of use, in painters' tape. Painters' tape adhesives are made for use in projects where the tape will adhere to a surface for less than a specified period of time, and if released prior to that specified period of time, will leave substantially no residue on the target surface. Examples of common target surfaces include painted walls and trim, woodwork, glass, faux painting, and wood floors.

Therefore, it is an aspect of the present invention to produce a system capable of applying a decorative pattern to a target surface that cleanly releases from a great range of target surfaces.

It is a further aspect of the present invention to produce a system capable of applying a decorative pattern to a target surface that includes a body capable of satisfactorily accepting established recesses

It is a still further aspect of the present invention to produce a system capable of applying a decorative pattern to a target surface that includes body dimensions that allow a user to choose a predetermined amount of length of the decorative pattern.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a sectional, plan view of an adhesive strip of the present invention.

FIG. 2 is a cutaway, plan view of adhesive strip of the present invention.

FIG. 3 is a cutaway, plan view of adhesive strip of the present invention.

FIG. 4 is a cutaway, plan view of adhesive strip of the present invention.

FIG. 5 is a cutaway, plan view of adhesive strip of the present invention.

FIG. 6 is an elevation view of the adhesive strip of the present invention, taken along view lines VI-VI.

FIG. 7 is a perspective view of the roll of painters' tape of the present invention.

FIG. 8 is an orthographic view of the adhesive strip of the present invention prior to paint ingress.

FIG. 9 is an orthographic view of the adhesive strip of the present invention after paint application.

FIG. 10 is an orthographic view of the adhesive strip of the present invention being peeled away after paint application.

### DETAILED DESCRIPTION

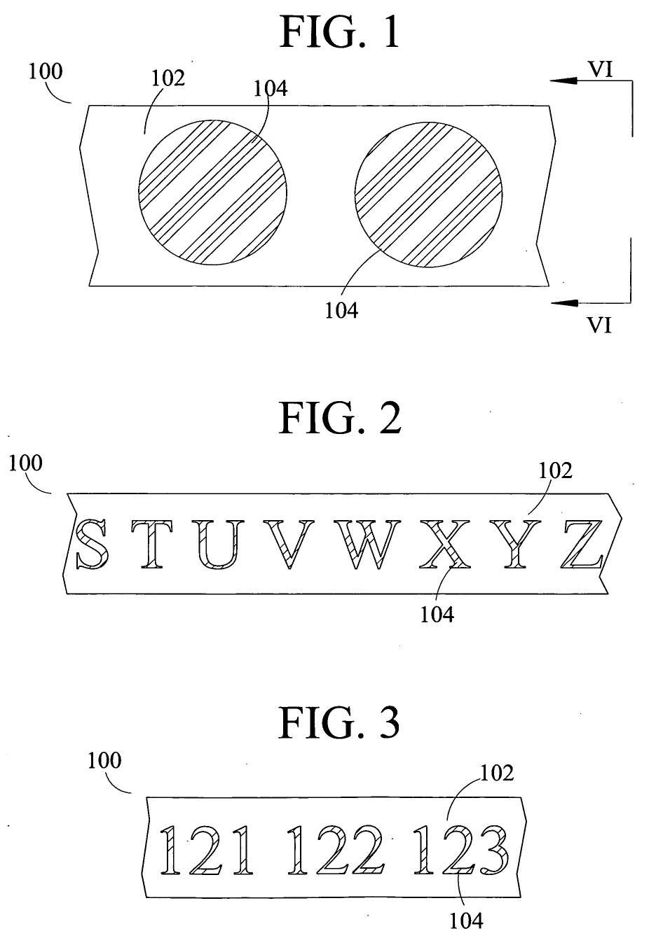

Referring first to FIG. 1, a portion of a basic embodiment of the adhesive strip 100 is shown. The adhesive strip 100 includes a continuous body 102 with multiple recesses 104. The body 102 of the adhesive tape 100 is continuous in that it presents substantial length that would allow a user to adorn household objects with portions of the invention. The continuous body allows users to select the specific length required for a specific decoration path and then remove unnecessary portions from the adhesive strip. A continuous body further allows a continuous pattern to be created; and moreover, because the pattern is continuous, a user may choose a single start point from multiple start points and a single end point from multiple end points when choosing the appropriate amount of adhesive strip to use in decorating. The pattern may be continuations of a single FIGURE, a frequently altering figure, a discontinuous figure, or any other sort of continuous figure. The body of the invention should have a length amenable to decorate common household objects, for example: a door, wood trim, a wall, and the like.

Multiple recesses 104 are disposed within the body 102 of the adhesive strip 100. The recess 104 is the absence of body mass that is configured on the body 102 to form a decorative pattern. The recesses 104 shown in FIG. 1 are inner recesses configured in a circular pattern. The inner recess is a recess 104 that is mostly enclosed within the body 102 of the adhesive strip 100. The specific aesthetic configuration of any particular recess 104 disclosed herein is not regarded as limiting the present invention. Although geometric decorations would likely have their uses, the invention comprises recesses of any configuration that can successfully be excised from the body of the adhesive strip. As FIGS. 2 and 3 show, the recesses 104 could even take the form of informational data: letters and numbers, respectively.

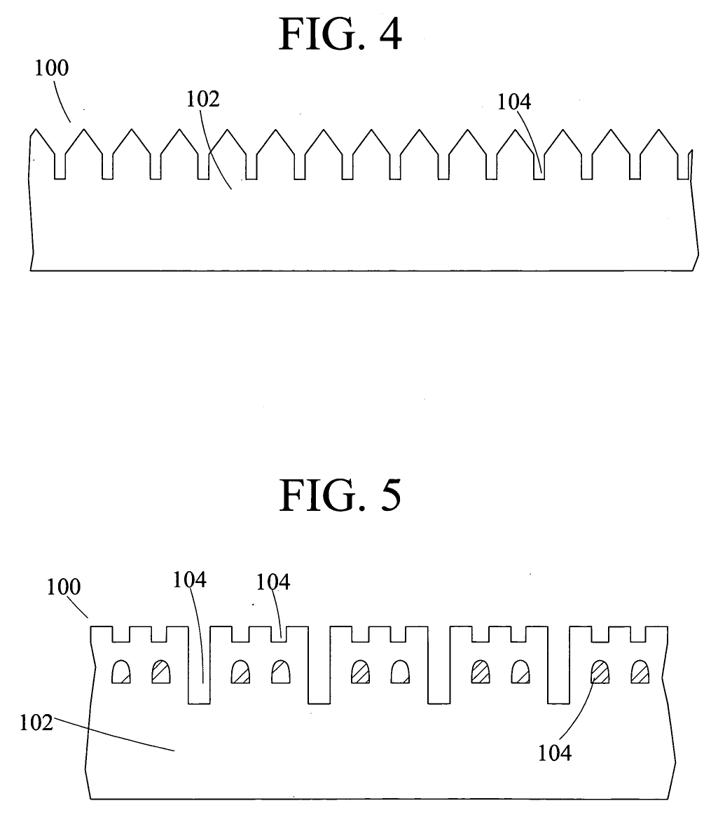

FIG. 4 shows an adhesive strip 100 of the present invention with outer recess. Outer recesses are recesses 104 that are disposed along the edge of the body 102. The version of the adhesive strip 100 in FIG. 4 exhibits a repeating recess pattern styled similar to a picket fence. As FIG. 5 depicts, the adhesive strip 100 could further include a body 102 with recesses 104 of both the outer and inner varieties.

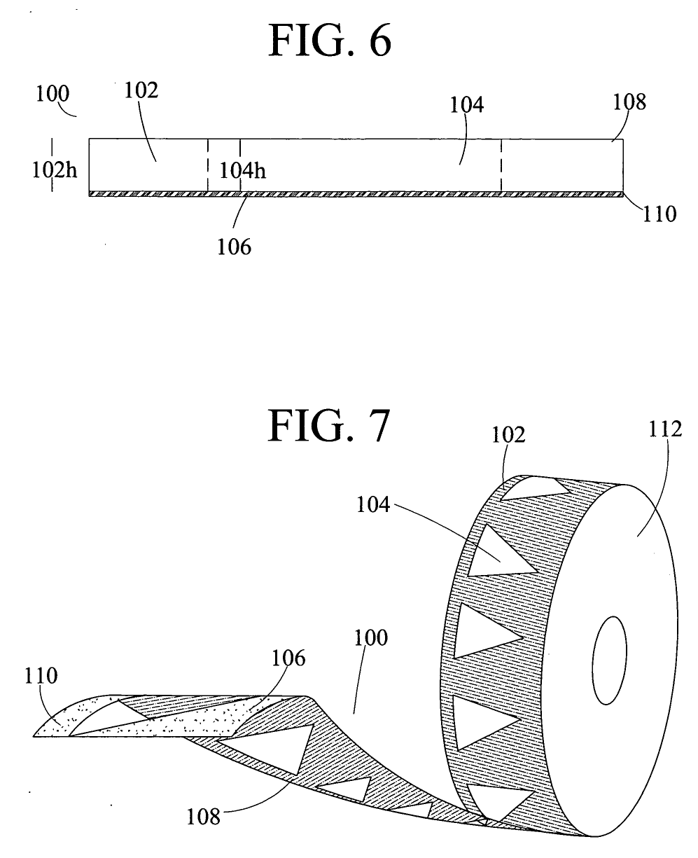

In FIG. 6, the dimensions of the adhesive strip 100 can be viewed more clearly. The recesses 104 have a recess depth 104h that is substantially equivalent to the body height 102h. The recesses 104 of the adhesive strip 100 must have a depth that allows a substantial portion of any paint to pass completely through the body 102 to form a decorative pattern dictated by the configuration of the recess 104. Thus the body height 102h need not necessarily be uniform throughout the body of the tape, but the portions of the body 102 proximate to the recesses 104 ought to have a height that is equivalent to the recess height 104h. The importance of the rough height equivalency is so that paint proceeding through a path that enters a recess is not impeded by portions of the body 102 jutting into the recess 104. That is to say, the perimeter of the recesses should be uniform from a dorsal surface 108 portion of the body to a ventral surface 110 portion of the body directly beneath. There is no required decorative shape for the recesses; the recess may be formed in any shape that is decorative. Preferred decorative shapes include geometric shapes, scenic designs, and repeated undulating patterns. The recess shown in FIG. 6 is an inner recess.

The recesses 104 of the present invention are portions of the body that have been previously excised, or were never in existence. The recess is the absence of body. The recesses exist to allow the passage of paint through, or past, the body. It is preferred that there is no covering, or additional layers covering the recesses; and it is generally preferred that the body 102 of the decorative adhesive strip 100 consist of a single layer.

The body 102, possessing the dorsal surface 108 and the ventral surface 110, further includes an adhesive compound 106 disposed upon the ventral surface 110. The body height 102h of the decorative adhesive strip 100 is uniform. By uniform height, it is meant that for most significant points of the dorsal surface 108, there will be a point directly beneath on the ventral surface 110. This allows for paint to be propelled accurately through the recesses 104 of the body 102 and on to a target surface. The adhesive compound 106 can be situated on the ventral surface 110 of the body 102 in a distinct layer, or the adhesive 106 can be spread upon the ventral surface 110 in amounts effective merely to both bind the adhesive strip 110 to a predetermined target surface and prevent substantial unwanted paint migration. Unwanted paint migration occurs when paint bound for either a target surface exposed by a recess or portions of the target surface exposed along the perimeter of the adhesive strip seeps under the ventral surface of the adhesive strip. This paint “bleeding” occurs typically when an adhesive compound is used that lacks the chemical bonding strength to seal tape to a surface, or bleeding could occur because the adhesive compound is not spread appropriately upon the ventral surface of tape. Such inappropriate adhesive compounds and inadequate distributions are to be avoided in the present invention.

General tape adhesives are inadequate for the adhesive strip 100 of the present invention. The purpose of most conventional tapes is to bond two articles in close relation for an indefinite amount of time. The adhesive of the present invention adheres in a specific fashion: cleanly. As a primary purpose of the present invention is to allow simple paint decoration, it is likely that the adhesive strip 100 will be placed on multiple varieties of target surfaces. By target surfaces, it is meant any type of surface commonly painted in a decorative fashion, including doors, window casings, wood, walls, metals, cloth, etc.

The adhesive compound is a substance capable of bonding to a surface for a limited period of time leaving only an insubstantial amount of residue. The ideal adhesives for the present invention include those found, or capable of use, in painters' tape. Painters' tape adhesives are made for use in projects where the tape will adhere to a surface for less than a specified period of time, and if released prior to that specified period of time, with leave substantially no residue on the target surface. Although conventional tapes are capable, to a certain extent, of shielding a surface from paint, when removed, the conventional tape will leave a sticky, unsightly residue where the conventional tape formerly resided. Painters' tape, however, when removed prior to its rating time will leave no substantial residue. That is to say, any clean up time or work will be minimal, and the average viewer would not be able to ascertain the portion of the surface that had previously been covered by the painters' tape.

Painters' tape can be purchased with various adhesive compositions. The primary system used in grading painters' tape adhesive compositions is by stating the number of days that the tape can be left on a surface without residue remaining after tape removal. The prominent painters' tape strengths are 7 and 14. However, many other grades of painters' tape exist such as grades 1, 3, 30 and 60. Each grade of adhesive has its own sets of strengths and weaknesses; grade 60 adheres minimally and is generally only for use with very smooth, delicate surfaces such as vinyl wallpaper or freshly painted walls, grade 1 for example can be used with common wood surfaces and metals.

Most of the adhesive compounds currently used with painters' tape would apply to the present invention. Painters' tapes typically include an adhesive comprised of a pressure-sensitive acryl-based resin. Acrylic adhesives have a low initial bonding strength, and it typically takes many hours—and depending upon additives, possibly days—for the compound to reach its maximum adhering strength. Acryl-based adhesives have a small initial tacking property and therefore can be repeatedly peeled off and stuck from and to a surface. Additionally, rubber-based adhesives and other adhesives commonly used with masking tape may be used with the present invention. Common masking tape adhesives, however, tend to only work on smooth surfaces, it does not work reliably on wood trim, and interior wall surfaces without environmental assistance, e.g. heating a room to approximately 80 degrees Fahrenheit prior to painting to increase the sealing properties of the tape to the target surface. For this reason, masking tape adhesive compositions are not preferred, but do apply to the present invention. The adhesives common in duct tape, electrical tape, packaging tape, or any of the other tapes on the market that are designed for purposes other than painting are generally incapable of sealing sufficiently to hold back paint, and more often than not, such adhesive compounds will adhere so well that damage accrues to the underlying surface when removed.

The adhesive compound necessary to the present invention fulfills two requirements lacking in ordinary tapes. The adhesive compound must seal to a degree necessary to hold back paint, but not seal to such an extent that damage to the underlying surface occurs upon removal. The particular amount of tack required for the adhesive will depend upon the particular embodiment of the adhesive strip. As the choices of adhesive compounds as they relate to tack and sealing properties are well established in the art, it would inappropriate to catalogue them here.

FIG. 7 shows a roll 112 of the adhesive strip 100. The continuous nature inherent in the body 102 of the adhesive strip 100 allows the invention to be rolled into a circular, condensed mass that allows for easy transport and use. The continuous body 102 is wound upon itself, the ventral surface 110 upon the dorsal surface 108. Because the adhesive strip 100 shares the properties of tapes, any known methods in the art of tape manufacturing to wind the adhesive strip into a roll should apply to the present invention.

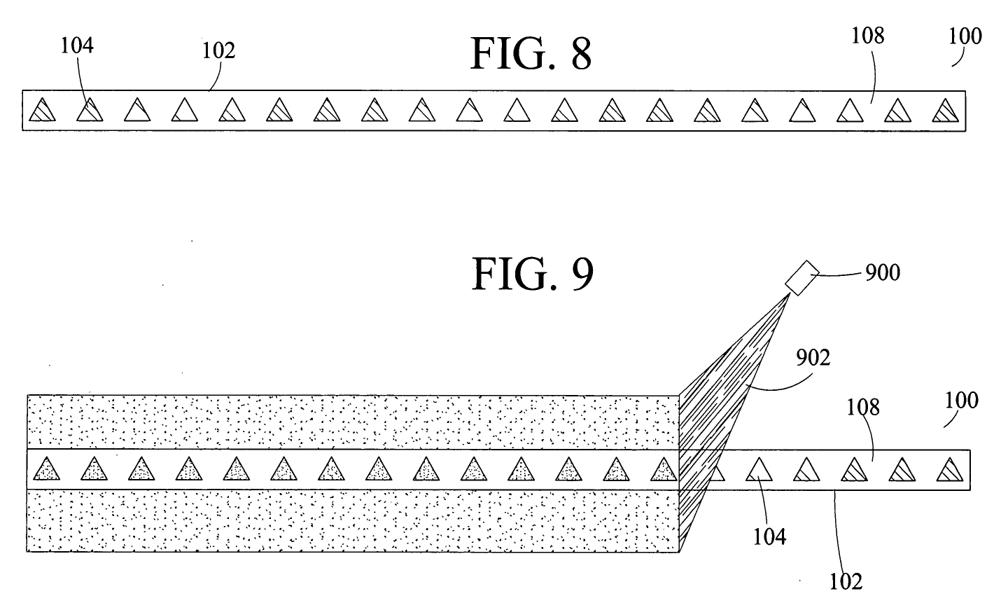

FIGS. 8-10 illustrate the adhesive strip in use on a target surface. Turning to FIG. 8, an effective amount of the decorative adhesive strip 100 is selected and is adhered to a target surface. The effective amount of decorative adhesive strip could be selected and torn or cut from a roll, or the effective amount could have been chosen from a longer strip of the present invention. An effective amount will depend on the personal taste of the user in deciding the number of painted decorations, supplied by the recesses (shaded with a combination of regular and broken lines for contrast), of the decorative adhesive strip. After the desired length of the decorative adhesive 100 strip is placed, paint is applied to the recesses 104 as is shown in FIG. 9. The amount of paint 902 applied should include an amount required to cover the area of the target surface as exposed by the decorative adhesive strip's recesses 104. Although the paint 902 can be sprayed from a nozzle device 900, shown here as being applied from left to right by a spray can nozzle, an appropriately-sized brush is probably the best means of applying paint—as it can be done in a highly controlled fashion. The present invention is, however, not meant to be restricted to any particular type of paint application method.

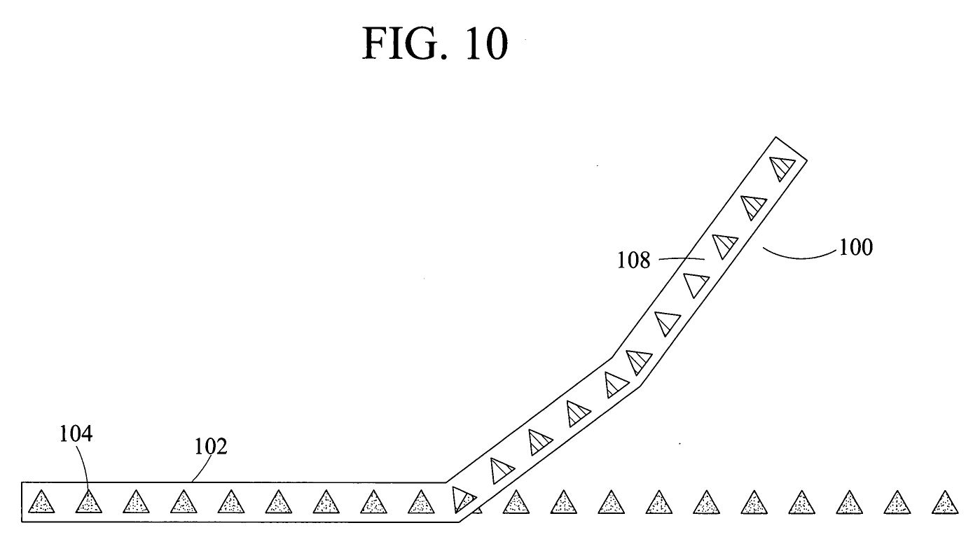

FIG. 10 demonstrates the method of releasing the decorative adhesive strip from the target surface. An end of the decorative adhesive strip is grasped and pulled away from the target surface in the direction of the dorsal surface 108 of the body 102. On the portions of the target surface exposed by the recesses 104 of the decorative adhesive strip 100, are decorations (shown as speckled figures) painted on to the target surface that corresponds to the configuration of the recesses 104 within the body 102. Because the adhesive compound of the present invention is adapted to both hinder unwanted paint migration and minimize adhesive residue, the painted decorations are substantially similar to the configuration of the recesses and the target surface is not extensively filled with residue.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A decorative painters' tape for applying a continuous pattern of paint to a target surface, said tape comprising:
a continuous body with a body height and multiple recesses of a recess depth substantially equal to said body height, said continuous body having a dorsal surface and a ventral surface; and
a cleanly releasable adhesive compound, contacting said ventral surface of said body, adapted to sealingly engage the target surface.

2. The decorative painters' tape of claim 1 wherein said multiple recesses form a repeating pattern.

3. The decorative painters' tape of claim 2 wherein said recesses are outer recesses.

4. The decorative painters' tape of claim 2 wherein said recesses are inner recesses.

5. The decorative painters' tape of claim 2 wherein said body consists of a single layer of material.

6. The decorative painters' tape of claim 2 wherein said adhesive includes a rubber-based adhesive.

7. The decorative painters' tape of claim 2 wherein said adhesive includes an acrylic-based adhesive.

8. A roll of decorative painters' tape for applying a continuous painted pattern to a target surface, said roll comprising:
a continuous body, having a dorsal surface and a ventral surface, with multiple uniform recesses, and wherein said continuous body is wound such that a substantial portion of said dorsal surface is in releasable contact with said ventral surface; and
a cleanly releasable adhesive compound, contacting said ventral surface of said body, adapted to sealingly engage the target surface

9. The decorative painters' tape of claim 8 wherein said multiple recesses form a repeating pattern.

10. The decorative painters' tape of claim 9 wherein said recesses are outer recesses.

11. The decorative painters' tape of claim 9 wherein said recesses are inner recesses.

12. The decorative painters' tape of claim 9 wherein said body consists of a single layer of material.

13. The decorative painters' tape of claim 9 wherein said adhesive includes a rubber-based adhesive.

14. The decorative painters' tape of claim 9 wherein said adhesive includes an acrylic-based adhesive.

15. A decorative adhesive strip for applying a painted pattern to a target surface, said strip comprising:
a continuous body, having a dorsal surface and a ventral surface, with preformed, uniform recesses; and
a cleanly releasable adhesive compound, contacting said ventral surface of said body, configured to sealingly adhere said continuous body to the target surface with a painters' tape adhesion rating of at least 1.

16. The adhesive strip of claim 15, wherein said adhesive compound is configured to adhere to a surface with a painters' tape adhesion rating of at least 3.

17. The adhesive strip of claim 16, wherein said adhesive compound is configured to adhere to a surface with a painters' tape adhesion rating of at least 7.

18. The adhesive strip of claim 17, wherein said adhesive compound is configured to adhere to a surface with a painters' tape adhesion rating of at least 14.

19. The adhesive strip of claim 18, wherein said adhesive compound is configured to adhere to a surface with a painters' tape adhesion rating of at least 30.

20. The adhesive strip of claim 15, wherein said body consists of a single layer of material.
